(19) United States
(12) Patent Application Publication
(10) Pub. No.: US 2017/0025101 A1
(43) Pub. Date: Jan. 26, 2017

(54) Bourbon Barrel Guitar

(71) Applicant: George Whitehead Mankel, III, Lexington, KY (US)

(72) Inventor: George Whitehead Mankel, III, Lexington, KY (US)

(21) Appl. No.: 14/807,888

(22) Filed: Jul. 24, 2015

(51) Int. Cl. G10D 1/08; G10D 3/06

(52) U.S. Cl. CPC G10D 1/085; G10D 3/06

(57) ABSTRACT

An electric guitar having a body, a neck having a first end and second end wherein the first end is connected to the body, a fretboard positioned on the neck and a headstock connected to the second end of the neck. The body, neck, fretboard and headstock are formed from wood from bourbon barrels.

### TECHNICAL FIELD

This disclosure relates generally to guitars and, more particularly, to an electric guitar formed substantially entirely of reclaimed white oak obtained from wood of used, reclaimed or recycled bourbon barrels.

### BACKGROUND

Central Kentucky (the Bluegrass Region) is home to most of the distilleries, large or small, that distill bourbon for distribution throughout the United States and additionally to countries throughout the world (with an exceptional interest and import status with Japan).

An electric guitar, (or electric bass, acoustic guitar, mandolin, or violin) may be hand fabricated entirely from reclaimed/recycled/used bourbon barrels with no other woods used in the manufacture and/or the building of the instrument. This explicit and intentional design resonates on many levels with music lovers, guitar players, musicians, fans and lovers of bourbon and the entire bourbon industry throughout the United States and the entire world.

### SUMMARY

According to one aspect of the present disclosure, an electric guitar is disclosed. The electric guitar includes: (1) a body; (2) a neck having a first end and second end wherein the first end is connected to the body; (3) a fretboard positioned on the neck; and (4) a headstock connected to the second end of the neck. The body, neck, fretboard and headstock are formed from wood from bourbon barrels.

In one embodiment, the headstock has a bourbon barrel shape. The wood may be reclaimed white oak from wood of used, reclaimed or recycled bourbon barrels. The electric guitar may include a compartment positioned within the body as well as a removable panel for accessing the compartment.

### BRIEF DESCRIPTION OF THE DRAWINGS

The accompanying drawings incorporated in and forming a part of the specification, illustrate several aspects of this disclosure, and together with the description serve to explain the principles of the disclosure. In the drawings:

FIG. 1 is a top view of a bourbon barrel guitar forming one aspect of this disclosure;

FIG. 2 is a front perspective view of a bourbon barrel forming one aspect of this disclosure;

FIG. 3 is a top view of the bourbon barrel forming one aspect of this disclosure;

FIG. 4 is a top view of the bourbon barrel that has been cut and separated for use in creating the top, back and neck of the bourbon barrel guitar forming one aspect of this disclosure;

FIG. 5 is top perspective view of the bourbon barrel guitar forming one aspect of this disclosure; and

FIG. 6 is front perspective view of the bourbon barrel that has been cut and separated for use in creating the body side walls of the bourbon barrel guitar forming one aspect of this disclosure.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the embodiments and like numerals represent like details in the various figures. Also, it is to be understood that other embodiments may be utilized and that process or other changes may be made without departing from the scope of the disclosure. The following detailed description is not to be taken in a limiting sense, and the scope of the invention is defined only by the appended claims and their equivalents. In accordance with the disclosure, a bourbon barrel guitar is hereinafter described.

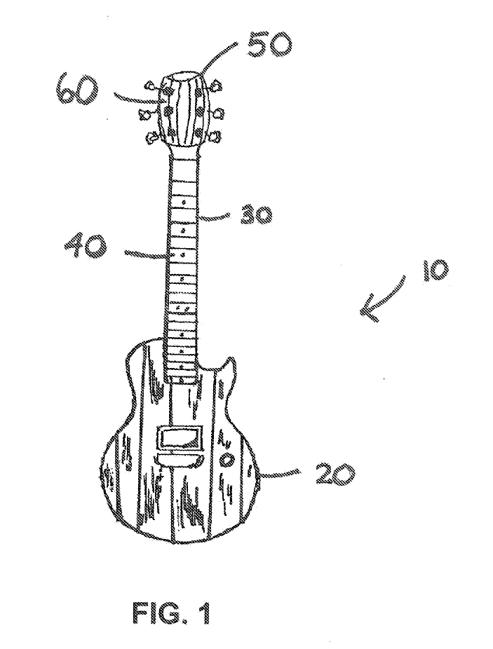

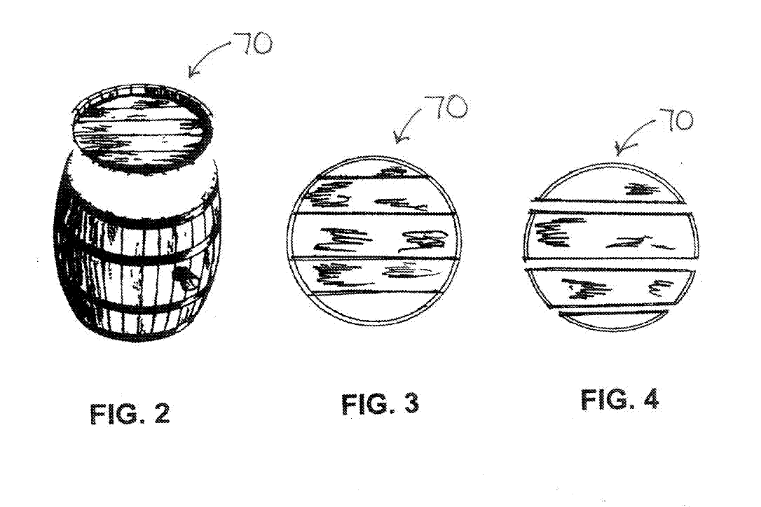

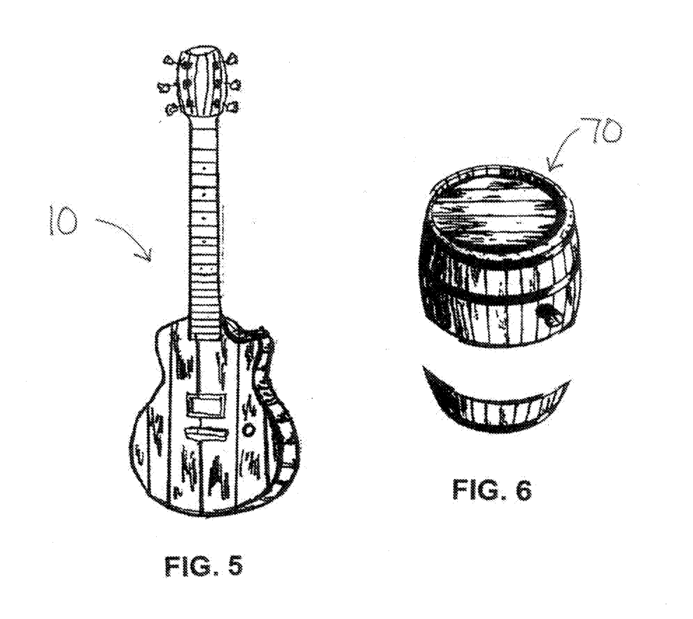

As shown in FIGS. 1-6, the bourbon barrel guitar 10 is an electric guitar made entirely out of reclaimed white oak obtained from the wood (heads and sides) of used/reclaimed/recycled bourbon barrels from barrels used to hold bourbon as it ages in the warehouses of each distillery in Kentucky. Kentucky produces approximately 95% of the world's production of bourbon.

The majority of production instruments will have six strings and will be industry standard in terms of available sizes and neck scale lengths. Individual wood components include the body 20, the neck 30, the fretboard 40, the control cavity cover, headstock 50 and the face of the headstock 60. Each component piece is constructed in a variety of designs.

The wood used in the entire manufacturing process of the bourbon barrel guitar disclosed herein is wood that comes from or is obtained from the used/reclaimed/recycled white oak barrels (with insides charred before being filled with the distilled alcohol that are used to store the bourbon once it is distilled). By law, bourbon has to be stored in a single barrel and aged a minimum of two years.

The bodies will eventually come in a variety of sizes, shapes and styles. Initial production will begin with the body size, style and shape of a first embodiment of the bourbon barrel guitar, which includes top, side, internal and back pieces.

The tops and backs are cut/machined/fabricated from the actual barrel lid pieces. These raw barrel pieces are approximately 1″ thick. There is no uniformity in size, width, or even parallel are trapezoidal shape of these pieces as they are manufactured by the cooperage company. Some are level and straight while many are not.

The pieces are re-sawn at a right angle from the initial jointed surface of the pieces comprising the top. Basically, the pieces are re-sawn in a “book-matched” fashion. The actual thicknesses of each piece will vary, depending and how straight the boards are in the horizontal plane as viewed from a vertical or upright position.

The edges of these now thinner barrel head pieces are joined at a 90 degree angle and also joined to be straight. They need to be planed at exactly 90 degrees, such as by using a jointer surfacing tool) so that when the pieces are glued next to one another, each glue/board seam will be completely straight thus allowing for a uniform glue joint between the pieces. Glue is applied and proper clamping technique is utilized. Glue is allowed to dry overnight or a minimum of twelve hours.

These pieces are now set aside for later use as both tops and backs for the solid, semi-hollow, chambered or compartmentalized bodies. There are no pieces in the barrel that allow for necks to be fabricated from a single piece. Some of the center pieces from the heads are long enough to fabricate a fretboard (varying scale lengths) from a single piece.

Necks can be fabricated from these same head center pieces in a process known as a scarf joint. This is a woodworking practice of cutting pieces at a specified angle, flipping one over and gluing the opposite side to the first piece. This allows a fixed angle into the piece that can now be fabricated as if it were a single piece of wood. Neck angles vary from 0-15 degrees. As shown in FIG. 1, the bourbon barrel guitar has a neck angle of 13 degrees.

Narrower pieces from this same location of the barrel head can be laminated in order to produce a glued piece for the neck blank. A center glue line serves as a symmetrical reference for fabrication.

The headstock of production models of the Bourbon Barrel Guitar will be shaped like a bourbon barrel. A truss rod channel is routed into the center line face of the neck blank. This flat horizontal surface will eventually serve as the glue joint location for the fretboard when it is attached (glued on).

A truss rod (various models of style, thickness and design) is then placed into the truss rod channel and fitted for proper location and height. The top of the truss rod should be the exact height/depth level of the truss rod canal. This allows for proper placement of the truss rod and proper gluing of the fretboard when it is time.

An option not in the embodiment illustrated in FIG. 1 but may used in the necks will be the use of graphite rods that will have channels routed that are parallel to the truss rod channel. These graphite reinforcement rods will vary in dimension but will be four-sided and not round. Their use is intended to add and provide three dimensional stability and stiffness to the necks once they are actually installed into the guitar, such that they function like an “I-beam” in engineering.

The fretboard scale length is determined. Generally, one of the industry standards of 24.75″, 25.0″ or 25.5″ fret scale lengths will be used. The fretboard is measured and cut to appropriate width at the nut/headstock end and also the body end. Neck width and thickness will vary but will be based on industry standard Dimensions. The nut width of is 1⅝″. The scale length is 24.75″. The guitar shown in FIG. 1 has 22 frets of medium height and width. Heel width is approximately 2 3/16″ in width at the end of the fretboard.

The fretboard is then slotted to the desired scale with a fret saw and or a Miter box fret slotting box and saw. Specific depth of cut will vary on a very small level due to the actual thickness of the fretboard and the actual depth of the saw cut.

Fretmarkers (dots or other inlay or markings) are now machined into the face of the fretboard and the side of the fretboard. There is an unlimited number of possibilities and materials that can be used for both. Some fretboards have no markings on their face or front.

In FIG. 1, the guitar has no markings or inlay on the face/front of the fretboard nor does it have fretboard side dot markers. These are centrally located in both the horizontal and the vertical axis of the bass (upper) side of the fretboard. They are approximately 3/32″ wide and drilled to a depth of 3/32″. The 12^{th} fret has two markers equidistant between the 11^{th} and the 12^{th} fret. Single markers are equidistant (counting from the headstock and moving towards the guitar body at the following frets: 3^{rd}, 5^{th}, 7^{th}, 9^{th}, 15^{th}, 17^{th}, 19^{th}, and the 21^{st} frets. These markers are actually the charcoal from the inside of the barrel mixed into superglue (cyanoacrylate).

The neck blank is now fabricated into the basic neck shape that is desired. The heel of the guitar is fabricated to 2 3/16″ in width. The neck is designed to be placed into a pocket in the body that is routed out (glued in or screwed in). The neck and fretboard are now ready to be glued together. The truss rod is placed into the truss rod channel and a snug/interference fit is achieved. The two graphite rods (one on each side of the truss rod) are placed into their channels and a snug/interference fit as achieved. Masking tape is placed over the truss rod and glue is evenly spread over the surface of the neck. Masking tape is removed and the fretboard is secured into the proper location and alignment and secured to dry for 12-24 hours.

The body construction will vary between models but the primary method will be the same as that used on the fabrication of the guitar. The process for creating the tops and the backs of the Bourbon Barrel Guitar only from the barrel heads is previously discussed. These panels are now cut into the shape of the tops and backs.

The guitar has a body shape that has a convex curved rounded butt end (approximately 13.5″ in width) moving into a narrower concave waist (approximately 9″ in width). The upper shoulder on the bass side is a narrower convex curve similar to the convex curved butt end of the guitar. It has a single concave cutaway on the treble side of the guitar that allows for easier playability and fret access to the upper frets. This basic body shape and cutaway are industry standard common features of many guitars manufactured over the past 75 years throughout the world.

The sides of the Bourbon Barrel Guitar are actually a non-specific number of pieces of the barrel staves (vertical pieces of the barrel) that are cut into varying thicknesses depending on the actual thickness of the top and the back. Approximate thickness will be 1.5″ in height. They will be cut and laid out into a pattern like that of laying out a wall using blocks or bricks one level high.

Because the radius of the staves is larger than the radius of the body, each piece will have to be cut and angled on the perimeter sides of each piece and also the outer edge of each piece. Convex curved areas (the waist and the cutaway area for upper fret access) outer facing surface will actually be the charred inside area of the stave. This is done to closely match the outline shape of the guitar and also allows a consistent thickness for the side walls of the guitar body.

Each piece is sanded to appropriate fit and glued into place. Only the sides of each piece are glued at this time. The top and the back are not glued to the body sides at this point. The side walls are allowed to dry for 12-24 hours.

The Bourbon Barrel Guitar instrument has a hidden compartment for a miniature bottle of bourbon. Because this instrument is fabricated from a barrel head that was originally used at the Buffalo Trace Distillery in Frankfort, Ky., and it still has the original markings complete. The hidden compartment may be used to accommodate a miniature bottle of bourbon. The hidden compartment is located behind/underneath the cut away on the treble side of the body. The back of the body also has a panel that is removable to see the actual construction of this hidden compartment. This is a proprietary part of the hand crafting of the instrument.

Hidden compartments will be part of each instrument. They will vary in actual size and location based upon what miniature bottles or flasks will be used in the construction of each individual instrument. Each will be accessed by a cover that is held in place with magnets and screws internally so that no screws are visible in the final appearance of the guitar. This includes the control cavity cover.

Before the neck is installed into the body, the fretwork needs to be completed. The fretboard is now ready to be radiused with a shaping block and/or bar. Standard fretboard radius options range from 7.25″ up to 16″ with the majority of guitars having either a 10″ or a 12″ radius being most common. It is important to use a properly radiused bridge that is compatable with the fretboard radius. If not, the string action will not be correct and the guitar will not “feel right” or play properly.

The fretboard is leveled and radiused. It is then sanded up to 800 grit paper for a glass like smoothness. Frets are now installed using a variety of proper fretting installation techniques. Frets are nipped on the edge, leveled and crowned. They are then sanded up to 1500 grit and then polished.

Next is fabrication and/or placement of the nut. This is a piece that is channeled the width of the fretboard at the head stock. It is made from a variety of hard/dense materials that the strings pass over and through.

Each string has a slot that will vary in width and depth based on the gauge of the string. It is slotted with appropriately sized files to an appropriate depth that will vary based on the string gauge.

If not already drilled and placed, the tuners for the strings will need to have holes drilled into the headstock in the proper alignment. Tuners can now be installed.

The bridge is also ready to be installed. Depending on the style, the holes for screws or bushings and bridge support posts will need to be appropriately and properly located and drilled.

A hole needs to drilled for the ¼″ plug-in jack. This will vary in size depending on what style of jack is used. Once the hole is drilled the jack assembly needs to be installed.

The neck now needs to be installed. This will be either by screws if it is a Bolt-on neck or it will be glued into the neck pocket.

The neck is secured with 4 screws through a neck plate or bushing grommets from the rear of the guitar body. Holes are drilled slightly smaller than the diameter of the neck screws. These screws will vary in length and diameter.

The screws pass through the body and into the neck thus securing it. Care has to be taken to make sure the neck is straight in the body as to the centerline of the body in order to achieve proper string location from the bridge to the barrel-shaped headstock.

Once the neck is installed, strings are placed on the guitar and it is tuned up to standard A440 Tuning Pitch. This is the proper way of checking the action or the string height from the fretboard (how easy the guitar is to play and to verify the intonation is correct from the bridge).

The guitar should sit for 24 hours and adjust into the new stresses placed on all parts of it due to the string tension.

It will become apparent whether or not the truss rod needs to be adjusted to achieve the proper amount of straightness, addressing back or forward “bowing” of the neck due to the tension of the strings and the height of the nut and bridge. Temperature and humidity are important factors in how the guitar “stabilizes”. Because it is made entirely from oak that will still have some residual moisture in the fibers (leftover bourbon) it is critical to let the guitar “settle in”.

At this point in time, the electronics (pickup(s) and potentiometers and any switches) strap buttons can be installed.

The Bourbon Barrel Guitar will have uniquely identifiable characteristics and mass appeal to guitarists, other musicians, bourbon fans and afficionados and collectors throughout the world.

Each Bourbon Barrel Guitar will be entirely and uniquely handcrafted due to the lack of uniformity and condition of the wood that is part of these used barrels. There is intrinsic value in hand crafted custom guitars that are visual and sonic works of art. Each Bourbon Barrel Guitar will be high-end examples of both.

The foregoing descriptions of various embodiments are provided for purposes of illustration, and are not intended to be exhaustive or limiting. Modifications or variations are also possible in light of the above teachings. The embodiments described above were chosen to provide the best application to thereby enable one of ordinary skill in the art to utilize the disclosed inventions in various embodiments and with various modifications as are suited to the particular use contemplated. All such modifications and variations are within the scope of the invention.

1. (canceled)

2. An electric guitar, comprising:
a body;
a neck having a first end and second end, wherein said first end connected to the body;
a fretboard positioned on the neck;
a headstock connected to the second end of the neck;
a compartment positioned within the body; and
a removable panel for accessing the compartment,
whereby the body, the neck, the fretboard and the headstock are formed from wood from bourbon barrels.

3. The electric guitar according to claim 2, wherein the headstock has a bourbon barrel shape.

4. The electric guitar according to claim 2, wherein the wood is reclaimed white oak from used, reclaimed or recycled bourbon barrels.

5. (canceled)

6. (canceled)
